(19) United States
(12) Patent Application Publication
(10) Pub. No.: US 2011/0166276 A1
(43) Pub. Date: Jul. 7, 2011

(54) ANTIVIBRATION RUBBER COMPOSITION

(75) Inventors: Nanako Fujii, Aichi-ken (JP); Toyohisa Tohyama, Aichi-ken (JP)

(73) Assignee: TOKAI RUBBER INDUSTRIES, LTD., Komaki-shi, Aichi-ken (JP)

(21) Appl. No.: 13/059,159

(22) PCT Filed: Aug. 6, 2010
(86) PCT No.: PCT/JP2010/063360

§ 371 Date: Feb. 15, 2011

(30) Foreign Application Priority Data
Aug. 7, 2009 (JP) 2009-184846
Jan. 29, 2010 (JP) 2010-017823

(51) Int. Cl. C08K 5/098; C08K 5/101

(52) U.S. Cl. 524/397; 524/318; 524/317; 524/291

(57) ABSTRACT

A vibration damping rubber composition is provided, which comprises:
(A) natural rubber (NR) as a major component;
(B) zinc monomethacrylate; and
(C) a sulfur-containing vulcanizing agent;
   wherein the component (B) is present in a proportion of 0.1 to 10 parts by weight based on 100 parts by weight of the component (A). The vibration damping rubber composition is excellent in vibration damping property as well as long-term thermal aging resistance.

### TECHNICAL FIELD

The present invention relates to a vibration damping rubber composition and, more specifically, to a vibration damping rubber composition to be used for an engine mount or the like adapted to support an engine in an automobile or the like and suppress transmission of vibrations.

### BACKGROUND ART

In general, vibration damping rubber compositions are used for reducing vibrations and noises in automobiles. In automotive applications, the vibration damping rubber compositions are required to have durability against thermal aging (thermal aging resistance) in addition to a vibration damping property. Particularly, there is a demand for improvement of the thermal aging resistance in newly developing countries such as China, India and Brazil.

Various types of rubbers are conventionally used as a polymer component for the vibration damping rubber compositions. Particularly, natural rubber (NR) is often used because it is inexpensive and excellent in vibration damping property. However, sulfur to be used as a vulcanizing agent for the natural rubber is liable to decompose in a high temperature atmosphere at a temperature of 100° C. or higher. Therefore, the vibration damping rubber compositions containing the natural rubber as the polymer component are liable to suffer from thermal aging attributable to weather or the like over time to be thereby deteriorated in physical properties.

To solve this problem, it is conventionally contemplated to use an ethylene-propylene-diene terpolymer (EPDM) together with the natural rubber as the polymer component and vulcanize the polymer component with a peroxide for improvement of the heat resistance (see, for example, a patent document PLT1).

### CITATION LIST

### Patent Literature

PLT1: JP-A-2008-280528

### SUMMARY OF INVENTION

### Technical Problem

For the peroxide vulcanization disclosed in the above patent document, however, a substantial amount of the peroxide-vulcanizable polymer such as the EPDM should be blended in the composition. This disadvantageously increases the material costs as compared with a case in which only the inexpensive natural rubber is used. For the vibration damping property, it is preferred to use only the natural rubber without blending the EPDM. Hence, there is a demand for improving the long-term thermal aging resistance while maintaining the characteristic properties of the natural rubber.

In view of the foregoing, it is an object of the present invention to provide a vibration damping rubber composition which is excellent in vibration damping property as well as long-term thermal aging resistance.

### Solution to Problem

To achieve the above object, a vibration damping rubber composition according to the present invention comprises:

(A) natural rubber (NR) as a major component;
(B) zinc monomethacrylate; and
(C) a sulfur-containing vulcanizing agent;

wherein the component (B) is present in a proportion of 0.1 to 10 parts by weight based on 100 parts by weight of the component (A).

The inventors of the present invention conducted intensive studies to solve the problem described above. In the course of the studies, the inventors performed experiments, in which various types of vulcanization assisting agents are added to natural rubber for vulcanization of the natural rubber with sulfur in order to improve the crosslinking for improvement of the heat resistance. As a result, the inventors found that, where a specific amount of zinc monomethacrylate is blended as the vulcanization assisting agent for the natural rubber, the durability is significantly improved in a long-term thermal aging test, and attained the present invention.

In general, acrylic acid is used as the vulcanization assisting agent for the natural rubber. However, acrylic acid has a smaller molecular weight and hence is highly reactive with the natural rubber, thereby causing thermal aging over time to deteriorate the physical properties of the rubber (e.g., to reduce the breaking elongation and the like). On the other hand, a metal methacrylate is moderately reactive with the natural rubber, thereby suppressing a change in crosslinking state in a high temperature atmosphere and breakage of polymer chains. Therefore, the resulting rubber composition is less liable to suffer from the deterioration of the physical properties due to the long-term thermal aging. Based on the experiments, the inventors found that zinc monomethacrylate is particularly excellent in this effect. Thus, a vulcanization product produced by vulcanizing the inventive vibration damping rubber composition is unprecedentedly improved in long-term thermal aging resistance in a high temperature atmosphere at a temperature of 100° C. or higher, while maintaining the characteristic properties of the natural rubber.

### Advantageous Effects of Invention

As described above, the inventive vibration damping rubber composition comprises the natural rubber (NR) as the major component and the sulfur-containing vulcanizing agent, and further comprises a specific proportion of zinc monomethacrylate as the vulcanization assisting agent. Therefore, the inventive vibration damping rubber composition is excellent in vibration damping property and collapse resistance as well as long-term thermal aging resistance. The inventive vibration damping rubber composition is advantageously used as a vibration damping material for engine mounts, stabilizer bushings, suspension bushings and the like in motor vehicles such as automobiles. Other exemplary applications of the inventive vibration damping rubber composition include vibration dampers for hard disks of computers, vibration dampers for domestic electrical appliances such as washing machines, and seismic damping (vibration damping) devices and seismic isolating devices such as architectural seismic damping walls and seismic dampers (vibration dampers) in architectural and housing fields.

Further, a diene rubber such as acrylonitrile-butadiene rubber (NBR), styrene-butadiene rubber (SBR), butadiene rubber (BR), isoprene rubber (IR) or chloroprene rubber (CR) may be blended in a proportion of less than 50 wt % with the natural rubber (NR). Even with the diene rubber thus blended in such a proportion, the inventive vibration damping rubber composition is excellent in vibration damping property and collapse resistance.

Where a specific mono(meth)acrylate such as 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, isobonyl methacrylate, tetrahydrofurfuryl acrylate, 2-phenoxyethyl methacrylate, isodecyl methacrylate or lauryl methacrylate is used in combination with zinc monomethacrylate described above, the inventive vibration damping rubber composition has sufficient spring characteristics in addition to heat resistance and permanent compression strain characteristics.

### DESCRIPTION OF EMBODIMENTS

Embodiments of the present invention will hereinafter be described in detail.

A vibration damping rubber composition according to the present invention contains natural rubber (A) as a major component, zinc monomethacrylate (B) and a sulfur-containing vulcanizing agent (C), and zinc monomethacrylate (B) is present in a proportion of 0.1 to 10 parts by weight (hereinafter referred to simply as “parts”) based on 100 parts of the natural rubber (A) in the vibration damping rubber composition. In the present invention, the term “major component” means a component which typically accounts for not less than 55 wt % of the entire rubber composition and significantly influences the characteristic properties of the composition.

In the inventive vibration damping rubber composition, as described above, zinc monomethacrylate (B) should be present in a proportion of 0.1 to 10 parts based on 100 parts of the natural rubber (A), and is preferably present in a proportion of 1.0 to 6.0 parts. If the proportion of zinc monomethacrylate is less than the aforementioned range, it is impossible to provide a thermal aging preventing effect as desired. If the proportion of zinc monomethacrylate is greater than the aforementioned range, on the other hand, the crosslinking state of the rubber composition is liable to change, thereby deteriorating the vibration damping property and the collapse resistance.

Further, a diene rubber such as acrylonitrile-butadiene rubber (NBR), styrene-butadiene rubber (SBR), butadiene rubber (BR), isoprene rubber (IR) and/or chloroprene rubber (CR) may be blended in a proportion of less than 50 wt % with the natural rubber (NR) as a polymer component of the inventive vibration damping rubber composition. These diene rubbers may be used either alone or in combination. As required, EPDM may be blended depending on the aforementioned blend proportion. Even with the diene rubber and EPDM blended in the aforementioned blend proportion with the natural rubber, the inventive vibration damping rubber composition is excellent in vibration damping property and collapse resistance. The component (B), which is a powdery material, is preferably blended in the form of a polymer batch for prevention of scattering thereof during the kneading of the rubber. As in the above case, NR, BR, NBR, EPDM and the like may be used either alone or in combination as a polymer for preparation of the polymer batch. Particularly, the polymer batch of the component (B) prepared by using the NR is preferred for dispersion of the component (B) in the rubber.

Examples of the sulfur-containing vulcanizing agent (C) to be used in combination with the components (A) and (B) include sulfur, sulfur chloride and other forms of sulfur (powdery sulfur, precipitated sulfur and insoluble sulfur), and 2-mercaptoimidazoline, dipentamethylenethiuram pentasulfide, which may be used either alone or in combination.

The sulfur-containing vulcanizing agent (C) is preferably blended in a proportion of 0.3 to 7 parts, particularly preferably 1 to 5 parts, based on 100 parts of the natural rubber (A). If the proportion of the vulcanizing agent is too small, it is impossible to provide a sufficient crosslinking structure, thereby deteriorating the dynamic magnification and the collapse resistance. If the proportion of the vulcanizing agent is too great, on the other hand, the heat resistance tends to be reduced.

Essential components of the inventive vibration damping rubber composition are the components (A) to (C), and a specific mono(meth)acrylate (D) such as 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, isobonyl methacrylate, tetrahydrofurfuryl acrylate, 2-phenoxyethyl methacrylate, isodecyl methacrylate and/or lauryl methacrylate is preferably used in combination with zinc monomethacrylate (B) as a vulcanization assisting agent. In this case, the inventive vibration damping rubber composition has more excellent spring characteristics in addition to heat resistance and permanent compression strain characteristics. The specific mono(meth)acrylates described above may be used either alone or in combination. The term “mono(meth)acrylate” herein means a monoacrylate or a monomethacrylate.

The specific mono(meth)acrylate (D) is preferably blended in a proportion of 0.5 to 10 parts, particularly preferably 1 to 6 parts, based on 100 parts of the natural rubber (A).

In the inventive vibration damping rubber composition, carbon black, process oil, an anti-aging agent, a process aid, a vulcanization accelerating agent, a white filler, a reactive monomer, a defoaming agent and the like may be blended with the aforementioned components as required. In the present invention, as described above, zinc monomethacrylate (B) is essentially used as the vulcanization assisting agent, but other vulcanization assisting agents such as metal monomethacrylates (an aluminum salt, a calcium salt, a magnesium salt and the like), metal dimethacrylates (a zinc salt, an aluminum salt, a calcium salt, a magnesium salt and the like), zinc oxide (ZnO), stearic acid and magnesium oxide may be blended in addition to the component (B).

Examples of the vulcanization accelerating agent include thiazole, sulfenamide, thiuram, aldehyde/ammonia, aldehyde/amine, guanidine and thiourea vulcanization accelerating agents, which may be used either alone or in combination. Particularly, a sulfenamide vulcanization accelerating agent is preferred because of its high crosslinking reactivity.

The vulcanization accelerating agent is preferably blended in a proportion of 0.5 to 7 parts, particularly preferably 0.5 to 5 parts, based on 100 parts of the natural rubber (A).

Examples of the thiazole vulcanization accelerating agent include dibenzothiazyl disulfide (MBTS), 2-mercaptobenzothiazole (MBT), sodium 2-mercaptobenzothiazole (NaMBT) and zinc 2-mercaptobenzothiazole (ZnMBT), which may be used either alone or in combination. Among these, dibenzothiazyl disulfide (MBTS) and 2-mercaptobenzothiazole (MBT) are preferred because of their excellent crosslinking reactivity.

Examples of the sulfenamide vulcanization accelerating agent include N-oxydiethylene-2-benzothiazolyl sulfenamide (NOBS), N-cyclohexyl-2-benzothiazolyl sulfenamide (CBS), N-t-butyl-2-benzothiazoyl sulfenamide (BBS) and N,N′-dicyclohexyl-2-benzothiazoyl sulfenamide.

Examples of the thiuram vulcanization accelerating agent include tetramethylthiuram disulfide (TMTD), tetraethylthiuram disulfide (TETD), tetrabutylthiuram disulfide (TBTD), tetrakis(2-ethylhexyl)thiuram disulfide (TOT) and tetrabenzylthiuram disulfide (TBzTD).

Examples of the anti-aging agent include carbamate anti-aging agents, phenylene diamine anti-aging agents, phenol anti-aging agents, diphenylamine anti-aging agents, quinoline anti-aging agents, imidazole anti-aging agents and waxes, which may be used either alone or in combination.

The anti-aging agent is preferably blended in a proportion of 1 to 10 parts, particularly preferably 2 to 5 parts, based on 100 parts of the natural rubber (A).

Examples of the process oil include naphthenic oil, paraffinic oil and aromatic oil, which may be used either alone or in combination.

The process oil is preferably blended in a proportion of 1 to 50 parts, particularly preferably 3 to 30 parts, based on 100 parts of the natural rubber (A).

The inventive vibration damping rubber composition is prepared by blending the aforementioned essential components (A) to (C) and, optionally, the other components (the component (D) and the like) described above by means of a kneading machine such as a kneader, a Banbury mixer, an open roll or a twin screw agitator. The rubber composition is heated to be vulcanized. The resulting vulcanization product is used for vibration damping applications. The vulcanization product is unprecedentedly improved in long-term thermal aging resistance in a high temperature atmosphere at a temperature of 100° C. or higher, while maintaining the characteristic properties of the natural rubber.

The inventive vibration damping rubber composition is advantageously used as a vibration damping material for engine mounts, stabilizer bushings, suspension bushings and the like in motor vehicles such as automobiles. Other exemplary applications of the inventive vibration damping rubber composition include vibration dampers for hard disks of computers, vibration dampers for domestic electrical appliances such as washing machines, and seismic damping (vibration damping) devices and seismic isolating devices such as architectural seismic damping walls and seismic dampers (vibration dampers) in architectural and housing fields.

### EXAMPLES

Next, inventive examples will be described in conjunction with comparative examples. However, the present invention is not limited to these inventive examples.

The following ingredients were prepared for the inventive examples and the comparative examples.

### NR

Natural rubber

### BR

Butadiene rubber available under NIPOLE 1220 from Nippon Zeon Corporation

### Zinc Oxide

Zinc Oxide Type II available from Sakai Chemical Industry Co., Ltd.

### Stearic Acid

LUNAC S30 available from Kao Corporation

### Anti-aging Agent

OZONON 6C available from Seiko Chemical Co., Ltd.

### Wax

SANNOC available from Ouchi Shinko Chemical Industrial Co., Ltd.

### Oil

Naphthenic oil available under DIANA PROCESS NM-280 from Idemitsu Kosan Co., Ltd.

### Carbon Black

ASAHI #50U (having an average particle diameter of 70 nm and a CTAB specific surface area of 27 m²/g) available from Asahi Carbon Co., Ltd.

### Vulcanization Accelerating Agent (i)

N-cyclohexyl-2-benzothiazolyl sulfenamide (CBS) available under NOCCELER CZ from Ouchi Shinko Chemical Industrial Co., Ltd.

### Vulcanization Accelerating Agent (ii)

Tetramethylthiuram disulfide (TMTD) available under SANCELER TT from Sanshin Chemical Industry Co., Ltd.

### Vulcanizing Agent

Sulfur available from Karuizawa Refinery KK

### Vulcanization Assisting Agent (i)

Zinc monomethacrylate available under PRO11542 from Sartomer Company Inc.

### Vulcanization Assisting Agent (ii)

Zinc dimethacrylate available under SR634 from Sartomer Company Inc.
Vulcanization Assisting Agent (iii)
Zinc diacrylate available under SR633 from Sartomer Company Inc.

### Vulcanization Assisting Agent (iv)

2-tert-butyl-6-(3-tert-butyl-2-hydroxy-5-methylbenzyl)-4-methylphenyl acrylate available under SUMIRIZER GM from Sumitomo Chemical Co., Ltd.

### Vulcanization Assisting Agent (v)

Stearyl methacrylate available under SR324 from Sartomer Company Inc.

### Vulcanization Assisting Agent (vi)

Tridecyl methacrylate available under SR493 from Sartomer Company Inc.
Vulcanization Assisting Agent (vii)
Polypropylene glycol monomethacrylate available under SR604 from Sartomer Company Inc.
Vulcanization Assisting Agent (viii)
Phenol EO-modified acrylate available under M101A from Toagosei Co., Ltd.

### Vulcanization Assisting Agent (ix)

Nonylphenol EO-modified acrylate available under M111 from Toagosei Co., Ltd.

### Vulcanization Assisting Agent (x)

Isobonyl methacrylate available under SR423 from Sartomer Company Inc.

### Vulcanization Assisting Agent (xi)

Tetrahydrofurfuryl acrylate available under SR285 from Sartomer Company Inc.
Vulcanization Assisting Agent (xii)
2-phenoxyethyl methacrylate available under SR340 from Sartomer Company Inc.
Vulcanization Assisting Agent (xiii)
Isodecyl methacrylate available under SR242 from Sartomer Company Inc.
Vulcanization Assisting Agent (xiv)
Laurylmethacrylate available under SR313 from Sartomer Company Inc.

### Example 1

First, 100 parts of NR, 5 parts of zinc oxide, 1 part of stearic acid, 1 part of anti-aging agent, 2 parts of wax, 3 parts of oil, 30 parts of carbon black and 0.1 part of vulcanization assisting agent (i) were blended, and kneaded together at 140° C. for 5 minutes by means of a Banbury mixer. Then, 1 part of vulcanizing agent, 2 parts of vulcanization accelerating agent (i) and 1 part of vulcanization assisting agent (ii) were blended with the resulting mixture, which was in turn kneaded at 60° C. for 5 minutes by means of an open roll. Thus, a vibration damping rubber composition was prepared.

### Examples 2 to 17 and Comparative Examples 1 to 7

Vibration damping rubber compositions were each prepared in substantially the same manner as in Example 1, except that the ingredients were blended in different proportions as shown in Tables 1 to 3.

The vibration damping rubber compositions of Examples and Comparative Examples thus prepared were evaluated based on the following criteria (only Examples 7 to 17 were evaluated for the spring characteristic). The results of the evaluation are also shown in Tables 1 to 3.

### Thermal Aging Test

The vibration damping rubber compositions were each press-formed (vulcanized) at 160° C. for 20 minutes, whereby 2-mm thick rubber sheets were prepared. The rubber sheets were punched into JIS No. 5 dumbbell test pieces, which were used for measurement of the breaking elongations (Eb) thereof in conformity with JIS K6251. It is noted that the measurement was carried out on an initial rubber sheet (before thermal aging), a rubber sheet thermally aged in a 100° C. atmosphere for 70 hours, a rubber sheet thermally aged in the 100° C. atmosphere for 500 hours, and a rubber sheet thermally aged in the 100° C. atmosphere for 1000 hours. Then, the percentages of reduction in breaking elongation (differences from the initial breaking elongation) after the respective thermal aging periods were determined, and shown in Tables 1 to 3. In the present invention, the percentage of reduction in breaking elongation in this test is required to be not higher than 10.0% after the 70-hour thermal aging, not higher than 40.0% after the 500-hour thermal aging, and not higher than 60.0% after the 1000-hour thermal aging. In the evaluation shown in Tables 1 to 3, a vibration damping rubber composition satisfying all of these requirements is indicated by ◯ (acceptable), and a vibration damping rubber composition satisfying not all of these requirements is indicated by X (unacceptable).

### Permanent Compression Strain

The vibration damping rubber compositions were each press-formed (vulcanized) at 160° C. for 30 minutes, whereby a test piece was prepared. The test piece was compressed by 25% at 100° C. for 500 hours in conformity with JIS K6262, and then the permanent compression strain of the test piece was measured. In the present invention, the permanent compression strain in this test was required to be less than 55%. In the evaluation shown in Tables 1 to 3, a vibration damping rubber composition satisfying this requirement is indicated by ◯ (acceptable), and a vibration damping rubber composition not satisfying this requirement is indicated by X (unacceptable).

### Spring Characteristic

The vibration damping rubber compositions were each press-formed (vulcanized) at 160° C. for 30 minutes, whereby a test piece was prepared. The dynamic spring constant (Kd100) and the static spring constant (Ks) of the test piece were measured in conformity with JIS K6394. The dynamic magnification (Kd100/Ks) was calculated based on the measurement values. A test piece having a dynamic magnification of not greater than 1.30 is indicated by ◯ (acceptable).

TABLE 1

| | (parts by weight) | | | | | |
|---|---|---|---|---|---|---|
| | Example | | | | | |
| | 1 | 2 | 3 | 4 | 5 | 6 |
| Natural rubber (NR) | 100 | 100 | 100 | 100 | 100 | 80 |
| Butadiene rubber (BR) | — | — | — | — | — | 20 |
| Zinc oxide | 5 | 5 | 5 | 5 | 5 | 5 |
| Stearic acid | 1 | 1 | 1 | 1 | 1 | 1 |
| Anti-aging agent | 1 | 1 | 1 | 1 | 1 | 1 |
| Wax | 2 | 2 | 2 | 2 | 2 | 2 |
| Oil | 3 | 3 | 3 | 3 | 3 | 3 |
| Carbon black | 30 | 30 | 30 | 30 | 30 | 30 |
| Vulcanization | 2 | 2 | 2 | 2 | 2 | 2 |
| accelerating agent (i) | | | | | | |
| Vulcanization | 1 | 1 | 1 | 1 | 1 | 1 |
| accelerating agent (ii) | | | | | | |
| Vulcanizing agent | 1 | 1 | 1 | 1 | 1 | 1 |
| Vulcanization | 0.1 | 3 | 6 | 10 | 3 | 6 |
| assisting agent (i) | | | | | | |
| Vulcanization | — | — | — | — | 3 | — |
| assisting agent (ii) | | | | | | |
| Vulcanization | — | — | — | — | — | — |
| assisting agent (iii) | | | | | | |
| Thermal aging test (%) | | | | | | |
| After 70 hours | 10 | 5 | 4 | 2 | 6 | 6 |
| After 500 hours | 40 | 33 | 30 | 28 | 30 | 30 |
| After 1000 hours | 58 | 55 | 52 | 50 | 48 | 48 |
| Evaluation | ◯ | ◯ | ◯ | ◯ | ◯ | ◯ |
| Permanent compression | 43 | 45 | 48 | 53 | 49 | 35 |
| strain (%) | | | | | | |
| Evaluation | ◯ | ◯ | ◯ | ◯ | ◯ | ◯ |

TABLE 2

| | (parts by weight) | | | | | | | | | | |
|---|---|---|---|---|---|---|---|---|---|---|---|
| | Example | | | | | | | | | | |
| | 7 | 8 | 9 | 10 | 11 | 12 | 13 | 14 | 15 | 16 | 17 |
| Natural rubber (NR) | 100 | 100 | 100 | 100 | 100 | 100 | 100 | 100 | 100 | 100 | 100 |
| Zinc oxide | 5 | 5 | 5 | 5 | 5 | 5 | 5 | 5 | 5 | 5 | 5 |
| Stearic acid | 1 | 1 | 1 | 1 | 1 | 1 | 1 | 1 | 1 | 1 | 1 |
| Anti-aging agent | 2 | 2 | 2 | 2 | 2 | 2 | 2 | 2 | 2 | 2 | 2 |
| Wax | 2 | 2 | 2 | 2 | 2 | 2 | 2 | 2 | 2 | 2 | 2 |
| Oil | 5 | 5 | 5 | 5 | 5 | 5 | 5 | 5 | 5 | 5 | 5 |
| Carbon black | 30 | 30 | 30 | 30 | 30 | 30 | 30 | 30 | 30 | 30 | 30 |
| Vulcanization accelerating agent (i) | 2 | 2 | 2 | 2 | 2 | 2 | 2 | 2 | 2 | 2 | 2 |
| Vulcanization accelerating agent (ii) | 1 | 1 | 1 | 1 | 1 | 1 | 1 | 1 | 1 | 1 | 1 |
| Vulcanizing agent | 1 | 1 | 1 | 1 | 1 | 1 | 1 | 1 | 1 | 1 | 1 |
| Vulcanization assisting agent (i) | 3 | 3 | 3 | 3 | 3 | 3 | 3 | 3 | 3 | 3 | 3 |
| Vulcanization assisting agent (iv) | 3 | — | — | — | — | — | — | — | — | — | — |
| Vulcanization assisting agent (v) | — | 3 | — | — | — | — | — | — | — | — | — |
| Vulcanization assisting agent (vi) | — | — | 3 | — | — | — | — | — | — | — | — |
| Vulcanization assisting agent (vii) | — | — | — | 3 | — | — | — | — | — | — | — |
| Vulcanization assisting agent (viii) | — | — | — | — | 3 | — | — | — | — | — | — |
| Vulcanization assisting agent (ix) | — | — | — | — | — | 3 | — | — | — | — | — |
| Vulcanization assisting agent (x) | — | — | — | — | — | — | 3 | — | — | — | — |
| Vulcanization assisting agent (xi) | — | — | — | — | — | — | — | 3 | — | — | — |
| Vulcanization assisting agent (xii) | — | — | — | — | — | — | — | — | 3 | — | — |
| Vulcanization assisting agent (xiii) | — | — | — | — | — | — | — | — | — | 3 | — |
| Vulcanization assisting agent (xiv) | — | — | — | — | — | — | — | — | — | — | 3 |
| Thermal aging test (%) | | | | | | | | | | | |
| After 70 hours | 6 | 6 | 6 | 6 | 6 | 6 | 6 | 6 | 6 | 6 | 6 |
| After 500 hours | 33 | 33 | 33 | 33 | 33 | 33 | 33 | 33 | 33 | 33 | 33 |
| After 1000 hours | 57 | 58 | 57 | 57 | 59 | 58 | 58 | 59 | 59 | 59 | 59 |
| Evaluation | ◯ | ◯ | ◯ | ◯ | ◯ | ◯ | ◯ | ◯ | ◯ | ◯ | ◯ |
| Permanent compression strain (%) | 42 | 45 | 48 | 45 | 45 | 45 | 48 | 49 | 50 | 50 | 49 |
| Evaluation | ◯ | ◯ | ◯ | ◯ | ◯ | ◯ | ◯ | ◯ | ◯ | ◯ | ◯ |
| Spring characteristic (dynamic magnification) | 1.30 | 1.25 | 1.24 | 1.30 | 1.30 | 1.25 | 1.28 | 1.30 | 1.26 | 1.28 | 1.25 |
| Evaluation | ◯ | ◯ | ◯ | ◯ | ◯ | ◯ | ◯ | ◯ | ◯ | ◯ | ◯ |

TABLE 3

| | (parts by weight) | | | | | | |
|---|---|---|---|---|---|---|---|
| | Comparative Example | | | | | | |
| | 1 | 2 | 3 | 4 | 5 | 6 | 7 |
| Natural rubber (NR) | 100 | 100 | 100 | 100 | 100 | 100 | 100 |
| Butadiene rubber (BR) | — | — | — | — | — | — | — |
| Zinc oxide | 5 | 5 | 5 | 5 | 5 | 5 | 5 |
| Stearic acid | 1 | 1 | 1 | 1 | 1 | 1 | 1 |
| Anti-aging agent | 1 | 1 | 1 | 1 | 1 | 1 | 1 |
| Wax | 2 | 2 | 2 | 2 | 2 | 2 | 2 |
| Oil | 3 | 3 | 3 | 3 | 3 | 3 | 3 |
| Carbon black | 30 | 30 | 30 | 30 | 30 | 30 | 30 |
| Vulcanization | 2 | 2 | 2 | 2 | 2 | 2 | 2 |
| accelerating agent (i) | | | | | | | |
| Vulcanization | 1 | 1 | 1 | 1 | 1 | 1 | 1 |
| accelerating agent (ii) | | | | | | | |
| Vulcanizing agent | 1 | 1 | 1 | 1 | 1 | 1 | 1 |
| Vulcanization | — | — | — | — | — | — | 12 |
| assisting agent (i) | | | | | | | |
| Vulcanization | — | 0.1 | 3 | 6 | 10 | — | — |
| assisting agent (ii) | | | | | | | |
| Vulcanization | — | — | — | — | — | 3 | — |
| assisting agent (iii) | | | | | | | |
| Thermal aging test (%) | | | | | | | |
| After 70 hours | 16 | 15 | 14 | 12 | 10 | 16 | 2 |
| After 500 hours | 48 | 43 | 37 | 34 | 32 | 40 | 27 |
| After 1000 hours | 65 | 58 | 55 | 52 | 50 | 59 | 48 |
| Evaluation | X | X | X | X | ◯ | X | ◯ |
| Permanent compression | 42 | 44 | 47 | 50 | 55 | 50 | 55 |
| strain (%) | | | | | | | |
| Evaluation | ◯ | ◯ | ◯ | ◯ | X | ◯ | X |

The above results indicate that the products of the Examples were excellent in permanent compression strain characteristic, and less liable to be degraded in breaking elongation characteristics even after the long-term thermal aging in the thermal aging test. Particularly, Examples 7 to 17, in which the specific monomethacrylate (D) was blended together with zinc monomethacrylate as the vulcanization assisting agent, were excellent in spring characteristic as well as the aforementioned characteristics.

On the other hand, Comparative Example 1, in which the vulcanization assisting agent was not blended, was poorer in breaking elongation characteristic due to the thermal aging. Comparative Examples 2 to 6, in which zinc dimethacrylate (vulcanization assisting agent (ii)) or zinc diacrylate (vulcanization assisting agent (iii)) was blended instead of zinc monomethacrylate, failed to satisfy the requirements for the breaking elongation characteristic after the long-term thermal aging and the permanent compression strain characteristic. In this regard, Comparative Examples 2 to 6 were inferior to the Examples. Comparative Example 7, in which zinc monomethacrylate (vulcanization assisting agent (i)) was blended in a proportion greater than the range specified by the present invention, was inferior in permanent compression strain characteristic.

In Example 6, the butadiene rubber (BR) was blended in a specific proportion with the natural rubber (NR) as the polymer component of the rubber composition. It was also experimentally confirmed that, where other diene rubbers (NBR, SBR, IR and CR) were blended, excellent results were achieved as in the Examples.

While specific forms of embodiments of the present invention have been described, it should be understood that these embodiments are merely illustrative of the invention but not limitative of the invention. Further, it is contemplated that modifications made within the equivalent scope of the appended claims fall within the scope of the present invention.

### INDUSTRIAL APPLICABILITY

The inventive vibration damping rubber composition is advantageously used as a vibration damping material for engine mounts, stabilizer bushings, suspension bushings and the like in motor vehicles such as automobiles. Other exemplary applications of the inventive vibration damping rubber composition include vibration dampers for hard disks of computers, vibration dampers for domestic electrical appliances such as washing machines, and seismic damping (vibration damping) devices and seismic isolating devices such as architectural seismic damping walls and seismic dampers (vibration dampers) in architectural and housing fields.

1. A vibration damping rubber composition comprising:
(A) natural rubber (NR) as a major component;
(B) zinc monomethacrylate; and
(C) a sulfur-containing vulcanizing agent;
wherein the component (B) is present in a proportion of 0.1 to 10 parts by weight based on 100 parts by weight of the component (A).

2. A vibration damping rubber composition as set forth in claim 1, wherein the component (A) comprises at least one diene rubber selected from the group consisting of acrylonitrile-butadiene rubber (NBR), styrene-butadiene rubber (SBR), butadiene rubber (BR), isoprene rubber (IR) and chloroprene rubber (CR), wherein the diene rubber is blended in a proportion of less than 50 wt % with the natural rubber (NR).

3. A vibration damping rubber composition as set forth in claim 1, comprising:
(D) at least one mono(meth)acrylate selected from the group consisting of 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, isobonyl methacrylate, tetrahydrofurfuryl acrylate, 2-phenoxyethyl methacrylate, isodecyl methacrylate and lauryl methacrylate.

4. A product produced by vulcanizing a vibration damping rubber composition as recited in claim 1.

5. A vibration damping rubber composition as set forth in claim 2, further comprising:
(D) at least one mono(meth)acrylate selected from the group consisting of 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, isobonyl methacrylate, tetrahydrofurfuryl acrylate, 2-phenoxyethyl methacrylate, isodecyl methacrylate and lauryl methacrylate.

6. A product produced by vulcanizing a vibration damping rubber composition as recited in claim 2.

7. A product produced by vulcanizing a vibration damping rubber composition as recited in claim 3.

8. A product produced by vulcanizing a vibration damping rubber composition as recited in claim 5.
